(19) United States
(12) Patent Application Publication
(10) Pub. No.: US 2023/0103568 A1
(43) Pub. Date: Apr. 6, 2023

(54) BATTERY AND ELECTRONIC DEVICE INCLUDING THE SAME

(71) Applicant: SAMSUNG ELECTRONICS CO., LTD., Suwon-si (KR)

(72) Inventors: Dol KIM, Suwon-si (KR); Jephil SHIN, Suwon-si (KR); Sukhyun LEE, Suwon-si (KR)

(21) Appl. No.: 17/952,758

(22) Filed: Sep. 26, 2022

Related U.S. Application Data
(63) Continuation of application No. PCT/KR2022/014053, filed on Sep. 20, 2022.

(30) Foreign Application Priority Data
Sep. 27, 2021 (KR) 10-2021-0127329

(51) Int. Cl. H01M 10/04; H01M 50/531

(52) U.S. Cl. CPC H01M 10/0431; H01M 50/531; H01M 2220/30; H01M 50/105

(57) ABSTRACT

An electronic device with a battery may include: a pouch; a first fixing member (e.g., adhesive); a second fixing member (e.g., adhesive); and an electrode assembly which is included in the pouch and in which a positive electrode plate disposed on an outermost side, a first separation membrane disposed on an inner side of the positive electrode plate, a negative electrode plate disposed on an inner side of the first separation membrane, and a second separation membrane disposed on an inner side of the negative electrode plate are stacked and wound, wherein the positive electrode plate may include a first outer surface oriented in one direction, and a second outer surface oriented in a direction opposite to the one direction, wherein the electrode assembly may include an upper end oriented in an upward direction and a lower end oriented in a direction opposite to the upward direction, wherein the second separation membrane may include a first inner surface adjacent and/or proximate to the first outer surface in the vicinity of a central portion thereof and a second inner surface adjacent and/or proximate to the second outer surface in the vicinity of the central portion, wherein the first fixing member may be configured to couple (directly or indirectly) a portion of an upper portion of the first inner surface, a portion of the upper end, and a portion of an upper portion of the first outer surface, and wherein the second fixing member may be configured to couple (directly or indirectly) a portion of the lower portion of the first inner surface, a portion of the lower end, and a portion of the lower portion of the first outer surface. Various other embodiments may be possible.

### CROSS REFERENCE TO RELATED APPLICATION

This application is a continuation of International Application No. PCT/KR2022/014053, designating the United States, filed on Sep. 20, 2022 in the Korean Intellectual Property Receiving Office, and claiming priority to Korean Patent Application No. 10-2021-0127329, filed on Sep. 27, 2021, the disclosures of which are all hereby incorporated herein by reference for all purposes as if fully set forth herein.

### FIELD

Various embodiments of the disclosure relate to a battery and an electronic device including the same.

### BACKGROUND

The use of an electronic device such as a bar-type, foldable-type, rollable-type, or sliding-type smartphone or a tablet PC is increasing.

The electronic device may include a battery for supplying power to at least one component disposed therein.

The battery may be a rechargeable secondary battery, and may be included in, for example, an electronic device to supply power to components such as a processor, a memory, and/or a sensor module (including at least one sensor) of the electronic device.

The battery included in an electronic device may be configured by winding, in the form of a jelly roll, an electrode assembly including a positive electrode plate, a negative electrode plate, and a separation membrane disposed between the positive electrode plate and the negative electrode plate, and enclosing the electrode assembly in a pouch or can-type case.

When the battery including the electrode assembly receives an external impact, the electrode plates (e.g., positive and negative electrode plates) disposed in a winding core (e.g., a roll-shaped central portion) may move or depart outward from the electrode assembly.

When the electrode plate of the winding core of the battery moves or departs outward from the electrode assembly, a short may occur between the positive electrode plate and the negative electrode plate disposed in the wining core, or the electrode plate of the winding core may come into contact with an electrode plate located on the outer surface, which may cause the occurrence of a short.

### SUMMARY

Various example embodiments are capable of providing a battery in which electrode plates (e.g., positive and/or negative electrode plates) disposed in the winding core of the electrode assembly is/are capable of being prevented, or reduced, from moving or breaking outward from the electrode assembly by using at least one fixing member, and an electronic device including the battery.

The technical problems to be addressed are not limited to those described above, and other technical problems, which are not described above, may be clearly understood by a person ordinarily skilled in the related art to which this disclosure belongs.

Various example embodiments may provide an electronic device including a battery, wherein the battery may include: a pouch; a first fixing member (e.g., a connector such as adhesive); a second fixing member (e.g., a connector such as adhesive); and an electrode assembly which is included in the pouch and in which a positive electrode plate disposed on an outermost side, a first separation membrane disposed on an inner side of the positive electrode plate, a negative electrode plate disposed on an inner side of the first separation membrane, and a second separation membrane disposed on an inner side of the negative electrode plate are stacked and wound, wherein the positive electrode plate may include a first outer surface oriented in one direction, and a second outer surface oriented in a direction opposite to the one direction, wherein the electrode assembly may include an upper end oriented in an upward direction and a lower end oriented in a direction opposite to the upward direction, wherein the second separation membrane may include a first inner surface adjacent and/or proximate to the first outer surface in the vicinity of a central portion thereof and a second inner surface adjacent and/or proximate to the second outer surface in the vicinity of the central portion, wherein the first fixing member may be configured to couple (directly or indirectly)a portion of an upper portion of the first inner surface, a portion of the upper end, and a portion of an upper portion of the first outer surface, and wherein the second fixing member may be configured to couple (directly or indirectly) a portion of the lower portion of the first inner surface, a portion of the lower end, and a portion of the lower portion of the first outer surface.

A battery according to various example embodiments may include: a pouch; a first fixing member; a second fixing member; and an electrode assembly which is included in the pouch and in which a positive electrode plate disposed on an outermost side, a first separation membrane disposed on an inner side of the positive electrode plate, a negative electrode plate disposed on an inner side of the first separation membrane, and a second separation membrane disposed on an inner side of the negative electrode plate are stacked and wound, wherein the positive electrode plate may include a first outer surface oriented in one direction, and a second outer surface oriented in a direction opposite to the one direction, wherein the electrode assembly may include an upper end oriented in an upward direction and a lower end oriented in a direction opposite to the upward direction, wherein the second separation membrane may include a first inner surface adjacent and/or proximate to the first outer surface in the vicinity of a central portion thereof and a second inner surface adjacent and/or proximate to the second outer surface in the vicinity of the central portion, wherein the first fixing member may be configured to couple a portion of an upper portion of the first inner surface, a portion of the upper end, and a portion of an upper portion of the first outer surface, and wherein the second fixing member may be configured to couple a portion of the lower portion of the first inner surface, a portion of the lower end, and a portion of the lower portion of the first outer surface.

Various example embodiments may provide an electronic device including a battery, wherein the battery may include: a pouch; and an electrode assembly which is included in the pouch and in which a positive electrode plate disposed on an outermost side, a first separation membrane disposed on an inner side of the positive electrode plate, a negative electrode plate disposed on an inner side of the first separation membrane, and a second separation membrane disposed on an inner side of the negative electrode plate are stacked and wound, wherein the positive electrode plate may include a first outer surface oriented in one direction, and a second outer surface oriented in a direction opposite to the one direction, wherein the electrode assembly may include an upper end oriented in an upward direction and a lower end oriented in a direction opposite to the upward direction, wherein the second separation membrane may include a first inner surface adjacent and/or proximate to the first outer surface in the vicinity of a central portion thereof and a second inner surface adjacent and/or proximate to the second outer surface in the vicinity of the central portion, wherein a positive electrode tab may be connected to the positive electrode plate disposed in the central portion, and a negative electrode tab may be connected to the negative electrode plate disposed in the central portion, and wherein at least a portion of the positive electrode tab, a portion of the positive electrode plate adjacent and/or proximate to the central portion, a portion of the lower end, and a portion of a lower portion of the second outer surface may be configured to be coupled by using a first tape.

According to various example embodiments, by using at least one fixing member, a portion of the first inner surface of the electrode assembly, the upper end and a portion of the first outer surface and/or a portion of the first inner surface, the lower end, and a portion of the first outer surface of the electrode assembly are coupled, and the electrode plates (e.g., the positive and/or negative electrode plates) disposed in the winding core of the electrode assembly are prevented, or reduced, from moving or breaking outward from the electrode assembly, whereby it is possible to secure stability of the battery against an external impact.

In addition, various effects directly or indirectly identified through the disclosure may be provided.

### BRIEF DESCRIPTION OF DRAWINGS

In connection with the description of the drawings, the same or similar components may be denoted by the same or similar reference numerals. The above and other aspects, features, and advantages of certain example embodiments of the present disclosure will be more apparent from the following detailed description, taken in conjunction with the accompanying drawings, in which:

FIG. 1A is a block diagram of an electronic device according to various embodiments in a network environment.

FIG. 1B is a block diagram illustrating a power management module and a battery according to various embodiments.

FIG. 2A is a front perspective view of an electronic device according to various embodiments.

FIG. 2B is a rear perspective view of the electronic device according to various embodiments.

FIG. 3 is an exploded perspective view of the electronic device according to various embodiments.

FIG. 4A is a view of a battery disposed inside an electronic device according to various embodiments when the battery is viewed in one direction (e.g., from the front side).

FIG. 4B is a perspective view of the electrode assembly according to various embodiments illustrated in FIG. 4A when the electrode assembly is rotated rightward and then viewed from the top side.

FIG. 4C is a view of the electrode assembly illustrated in FIG. 4B when viewed in one direction (e.g., from the bottom side) according to various embodiments.

FIG. 5A is a perspective view of an electrode assembly of a battery according to various embodiments when the electrode assembly is viewed from the top side.

FIG. 5B is a perspective view of the electrode assembly according to various embodiments illustrated in FIG. 5A when the electrode assembly is viewed from the bottom side.

FIG. 6A is a perspective view of an electrode assembly of a battery according to various embodiments when the electrode assembly is viewed from the top side.

FIG. 6B is a perspective view of the electrode assembly according to various embodiments illustrated in FIG. 6A when the electrode assembly is rotated (e.g., about) 180° and then viewed from the top side.

FIG. 7A is a perspective view of an electrode assembly of a battery according to various embodiments when the electrode assembly is viewed from the top side.

FIG. 7B is a perspective view of the electrode assembly according to various embodiments illustrated in FIG. 7A when the electrode assembly is viewed from the bottom side.

### DETAILED DESCRIPTION

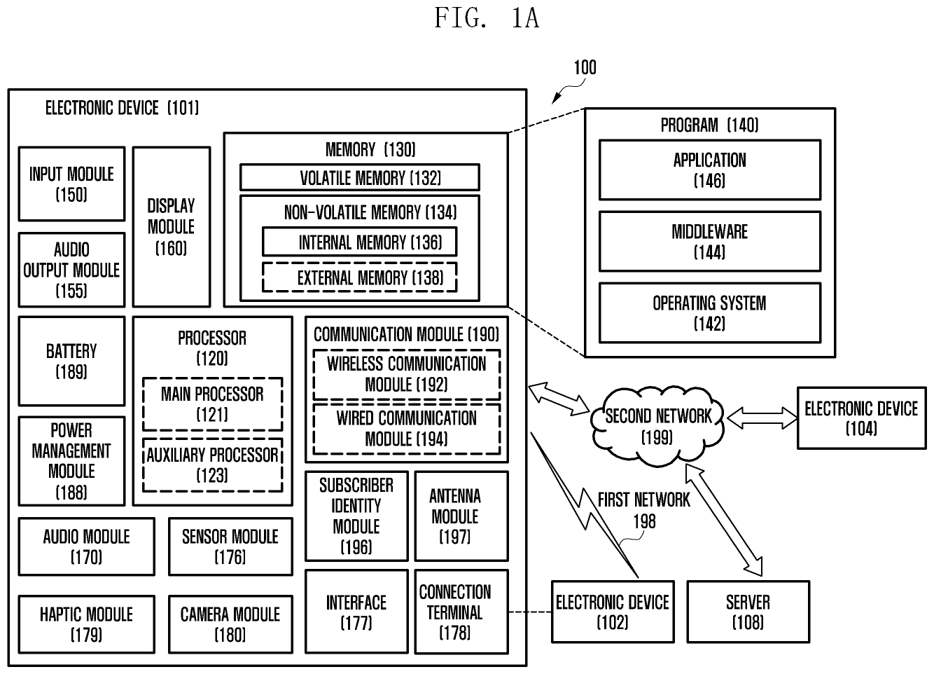

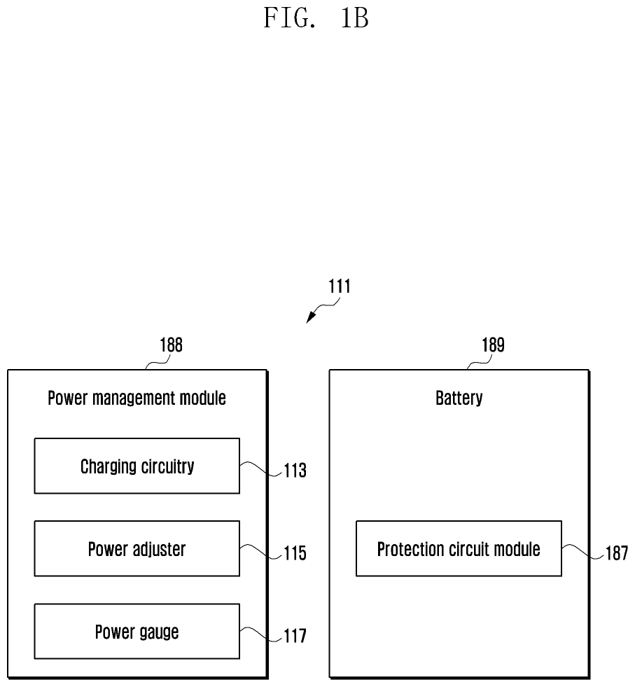

FIG. 1A is a block diagram of an electronic device according to various embodiments in a network environment.

Referring to FIG. 1A, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134 (which may include internal memory 136 and/or external memory 138). According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199).

According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas.

The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 1B is a block diagram 111 illustrating the power management module 188 and the battery 189 according to various embodiments.

Referring to FIG. 1B, the power management module 188 may include charging circuitry 113, a power adjuster 115, or a power gauge 117. The charging circuitry 113 may charge the battery 189 by using power supplied from an external power source outside the electronic device 101. According to an embodiment, the charging circuitry 113 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 189, and may charge the battery 189 using the selected charging scheme. The external power source may be connected with the electronic device 101, for example, directly via the connecting terminal 178 or wirelessly via the antenna module 197.

The power adjuster 115 may generate a plurality of powers having different voltage levels or different current levels by adjusting a voltage level or a current level of the power supplied from the external power source or the battery 189. The power adjuster 115 may adjust the voltage level or the current level of the power supplied from the external power source or the battery 189 into a different voltage level or current level appropriate for each of some of the components included in the electronic device 101. According to an embodiment, the power adjuster 115 may be implemented in the form of a low drop out (LDO) regulator or a switching regulator. The power gauge 117 may measure use state information about the battery 189 (e.g., a capacity, a number of times of charging or discharging, a voltage, or a temperature of the battery 189).

The power management module 188 may determine, using, for example, the charging circuitry 113, the power adjuster 115, or the power gauge 117, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment, at least some of the functions of the power management module 188 may be performed by an external control device (e.g., the processor 120).

The battery 189, according to an embodiment, may include a protection circuit module (PCM) 187. The PCM 187 may perform one or more of various functions (e.g., a pre-cutoff function) to prevent a performance deterioration of, or a damage to, the battery 189. The PCM 187, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment, at least part of the charging state information or use state information regarding the battery 189 may be measured using a corresponding sensor (e.g., a temperature sensor) of the sensor module 176, the power gauge 117, or the power management module 188. According to an embodiment, the corresponding sensor (e.g., a temperature sensor) of the sensor module 176 may be included as part of the PCM 187, or may be disposed near the battery 189 as a separate device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element.

As used in connection with various embodiments, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

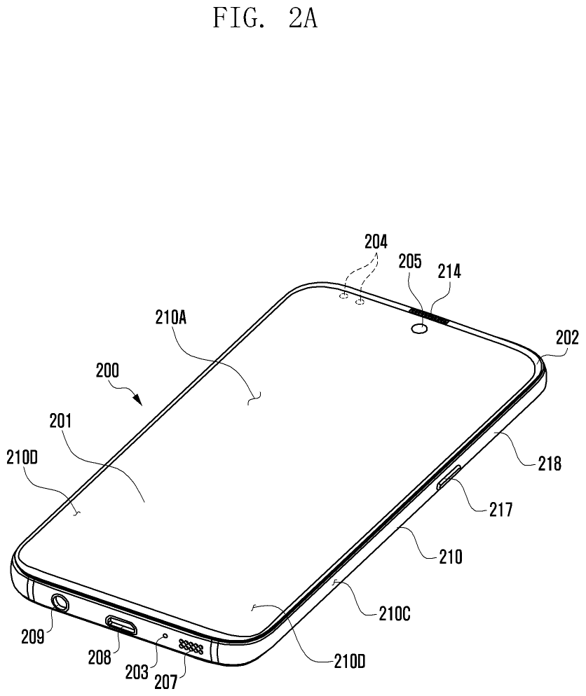

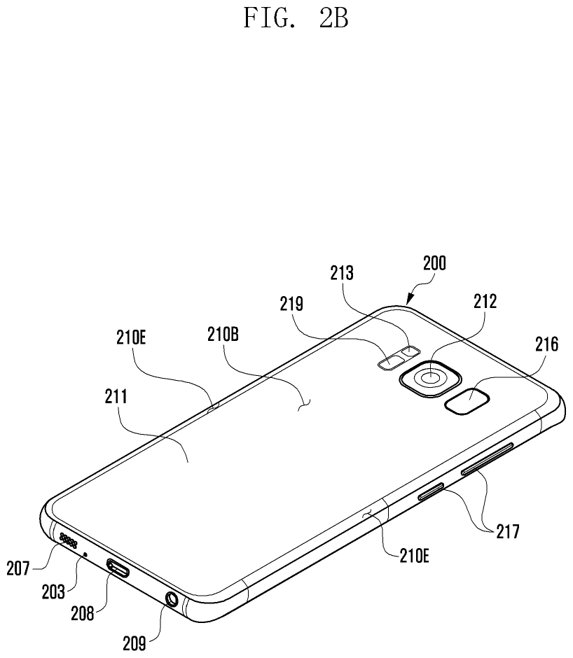

FIG. 2A is a front perspective view of an electronic device according to various embodiments. FIG. 2B is a rear perspective view of the electronic device according to various embodiments.

Referring to FIG. 2A and FIG. 2B, an electronic device 200 according to an embodiment may include a housing 210 including a first surface (or front surface) 210A, a second surface (or rear surface) 210B, and a side surface 210C surrounding the space between the first surface 210A and the second surface 210B. In another embodiment (not illustrated), the housing may denote a structure that forms a part of the first surface 210A, the second surface 210B, and the side surface 210C illustrated in FIG. 2A and FIG. 2B. According to an embodiment, the first surface 210A may be formed by a front plate 202, at least a part of which is substantially transparent (for example, a glass plate including various coating layers, or a polymer plate). The second surface 210B may be formed by a rear plate 211 that is substantially opaque. The rear plate 211 may be made of coated or colored glass, ceramic, polymer, metal (for example, aluminum, stainless steel (STS), or magnesium), or a combination of at least two of the above-mentioned materials. The side surface 210C may be formed by a side bezel structure (or “side member”) 218 which is coupled to the front plate 202 and to the rear plate 211, and which includes metal and/or polymer. In some embodiments, the rear plate 211 and the side bezel structure 218 may be formed integrally and may include the same material (for example, a metal material such as aluminum).

In the illustrated embodiment, the front plate 202 may include two first areas 210D on both ends of the long edge of the front plate 202 such that the two first areas 210D bend from the first surface 210A toward the rear plate 211 and extend seamlessly. In the illustrated embodiment (see FIG. 2B), the rear plate 211 may include two second areas 210E on both ends of the long edge such that the two second areas 210E bend from the second surface 210B toward the front plate 202 and extend seamlessly. In some embodiments, the front plate 202 (or the rear plate 211) may include only one of the first areas 210D (or the second areas 210E). In another embodiment, a part of the first areas 210D or the second areas 210E may not be included. In the above embodiments, when seen from the side surface of the electronic device 200, the side bezel structure 218 may have a first thickness (or width) on a part of the side surface, which does not include the first areas 210D or the second areas 210E as described above, and may have a second thickness that is smaller than the first thickness on a part of the side surface, which includes the first areas 210D or the second areas 210E.

According to an embodiment, the electronic device 200 may include at least one of a display 201, audio modules 203, 207, and 214, sensor modules 204 and 219, camera modules 205, 212, and 213, a key input device 217, indicator, and connector holes 208 and 209. In some embodiments, at least one of the constituent elements (for example, the key input device 217 or indicator) of the electronic device 200 may be omitted, or the electronic device 200 may additionally include another constituent element.

The display 201 may be exposed through a corresponding part of the front plate 202, for example. In some embodiments, at least a part of the display 201 may be exposed through the front plate 202 that forms the first areas 210D of the side surface 210C and the first surface 210A. In some embodiments, the display 201 may have a corner formed in substantially the same shape as that of the adjacent outer periphery of the front plate 202. In another embodiment (not illustrated), in order to increase the area of exposure of the display 201, the interval between the outer periphery of the display 201 and the outer periphery of the front plate 202 may be formed to be substantially identical.

In another embodiment (not illustrated), a recess or an opening may be formed in a part of the screen display area of the display 201, and at least one of an audio module 214, a sensor module 204, a camera module 205, and a light-emitting element 206 may be included and aligned with the recess or the opening. In another embodiment (not illustrated), on the back surface of the screen display area of the display 201, at least one of an audio module 214, a sensor module 204, a camera module 205, a fingerprint sensor 216, and a light-emitting element 206 may be included. In another embodiment (not illustrated), the display 201 may be coupled to or arranged adjacent to a touch sensing circuit, a pressure sensor capable of measuring the intensity (pressure) of a touch, and/or a digitizer that detects a magnetic field-type stylus pen. In some embodiments, at least a part of the sensor modules 204 and 219 and/or at least a part of the key input device 217 may be arranged in the first areas 210D and/or the second areas 210E.

The audio modules may include a microphone hole 203 and speaker holes 207 and 214. A microphone for acquiring an external sound may be arranged in the microphone hole 203, and a plurality of microphones may be arranged therein such that the direction of a sound can be sensed in some embodiments. The speaker holes 207 and 214 may include an outer speaker hole 207 and a speech receiver hole 214. In some embodiments, the speaker holes 207 and 214 and the microphone hole 203 may be implemented as a single hole, or a speaker may be included (for example, a piezoelectric speaker) without the speaker holes 207 and 214.

The sensor modules 204, 216, and 219 may generate an electric signal or a data value corresponding to the internal operating condition of the electronic device 200 or the external environment condition thereof. The sensor modules 204, 216, and 219 may include, for example, a first sensor module 204 (for example, a proximity sensor) arranged on the first surface 210A of the housing 210, and/or a second sensor module (not illustrated) (for example, a fingerprint sensor), and/or a third sensor module 219 (for example, an HRM sensor) arranged on the second surface 210B of the housing 210, and/or a fourth sensor module 216 (for example, a fingerprint sensor). The fingerprint sensor may be arranged not only on the first surface 210A (for example, the display 201) of the housing 210, but also on the second surface 210B thereof. The electronic device 200 may further include a sensor module not illustrated, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or a luminance sensor 204.

The camera modules 205, 212, and 213 may include a first camera device 205 arranged on the first surface 210A of the electronic device 200, a second camera device 212 arranged on the second surface 210B thereof, and/or a flash 213. The camera devices 205 and 212 may include a single lens or a plurality of lenses, an image sensor, and/or an image signal processor. The flash 213 may include, for example, a light-emitting diode or a xenon lamp. In some embodiments, two or more lenses (an infrared camera, a wide-angle lens, and a telephoto lens) and image sensors may be arranged on a single surface of the electronic device 200.

The key input device 217 may be arranged on the side surface 210C of the housing 210. In another embodiment, the electronic device 200 may not include a part of the above-mentioned key input device 217 or the entire key input device 217, and the key input device 217 (not included) may be implemented in another type, such as a soft key, on the display 201. In some embodiments, the key input device may include a sensor module 216 arranged on the second surface 210B of the housing 210.

The indicator may be arranged on the first surface 210A of the housing 210, for example. The indicator may provide information regarding the condition of the electronic device 200 in a light type, for example. In another embodiment, the indicator may provide a light source that interworks with operation of the camera module 205, for example. The indicator may include, for example, an LED, an IR LED, and a xenon lamp.

The connector holes 208 and 209 may include a first connector hole 208 capable of containing a connector (for example, a USB connector) for transmitting/receiving power and/or data to/from an external electronic device, and/or a second connector hole (for example, an earphone jack) 209 capable of containing a connector for transmitting/receiving an audio signal to/from the external electronic device.

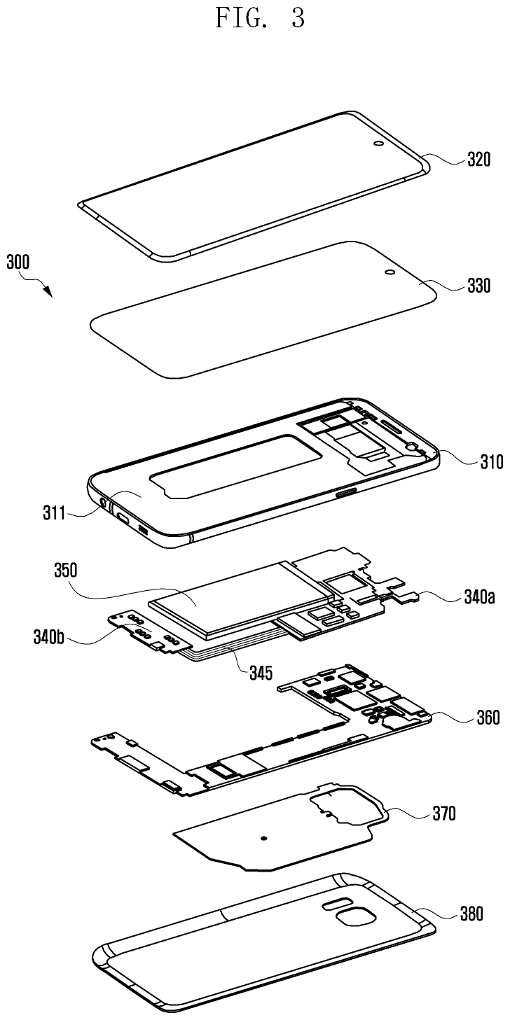

FIG. 3 is an exploded perspective view of the electronic device according to various embodiments.

Referring to FIG. 3, the electronic device 300 may include a side bezel structure 310, a first support member 311 (for example, a bracket), a front plate 320, a display 330, a printed circuit boards 340 (e.g., see 340a and 340b), a battery 350, a second support member 360 (for example, a rear case), an antenna 370, and a rear plate 380. In some embodiments, at least one of the constituent elements (for example, the first support member 311 or the second support member 360) of the electronic device 300 may be omitted, or the electronic device 300 may further include another constituent element. At least one of the constituent elements of the electronic device 300 may be identical or similar to at least one of the constituent elements of the electronic device 101 or 200 of FIG. 1 to FIG. 2B, and repeated descriptions thereof will be omitted herein.

The first support member 311 may be arranged inside the electronic device 300 and connected to the side bezel structure 310, or may be formed integrally with the side bezel structure 310. The first support member 311 may be made of a metal material and/or a nonmetal (for example, polymer) material, for example. The display 330 may be coupled to one surface of the first support member 311, and the printed circuit board 340 may be coupled to the other surface thereof. A processor, a memory, and/or an interface may be mounted on the printed circuit board 340. The processor may include, for example, one or more of a central processing device, an application processor, a graphic processing device, an image signal processor, a sensor hub processor, or a communication processor.

According to various embodiments, at least a portion of the printed circuit board 340 may be located in a first direction (e.g., upper side) and/or a second direction (e.g., lower side) of the electronic device 300. The printed circuit board 340 may include, for example, a structure in which a plurality of printed circuit boards (PCBs) are stacked. For example, the printed circuit board 340 may include an interposer structure. The printed circuit board 340 may be implemented in the form of a flexible printed circuit board (FPCB) and/or the form of a rigid printed circuit board (PCB). The printed circuit board 340 provided in the first direction (e.g., upper side) and the second direction (e.g., lower side) may be electrically connected through a signal connection member 345 (e.g., a coaxial cable or an FPCB).

The memory may include a volatile memory or a non-volatile memory, for example.

The interface may include, for example, a high definition multimedia interface (HDMI), a universal serial bus (USB) interface, an SD card interface, and/or an audio interface. The interface may connect the electronic device 300 with an external electronic device electrically or physically, for example, and may include a USB connector, an SD card/MMC connector, or an audio connector.

The battery 350 is a device for supplying power to at least one constituent element of the electronic device 300, and may include a non-rechargeable primary cell, a rechargeable secondary cell, or a fuel cell, for example. At least a part of the battery 350 may be arranged on substantially the same plane with the printed circuit board 340, for example. The battery 350 may be arranged integrally inside the electronic device 300, or may be arranged such that the same can be attached to/detached from the electronic device 300.

The antenna 370 may be arranged between the rear plate 380 and the battery 350. The antenna 370 may include, for example, a near field communication (NFC) antenna, a wireless charging antenna, and/or a magnetic secure transmission (MST) antenna. The antenna 370 may conduct near-field communication with an external device or may wirelessly transmit/receive power necessary for charging, for example. In another embodiment, an antenna structure may be formed by a part or a combination of the side bezel structure 310 and/or the first support member 311.

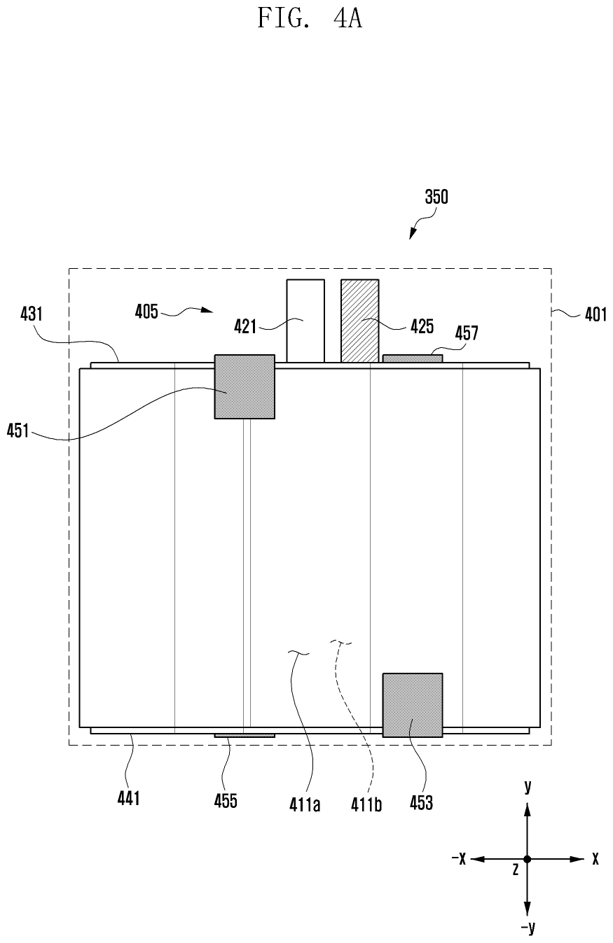

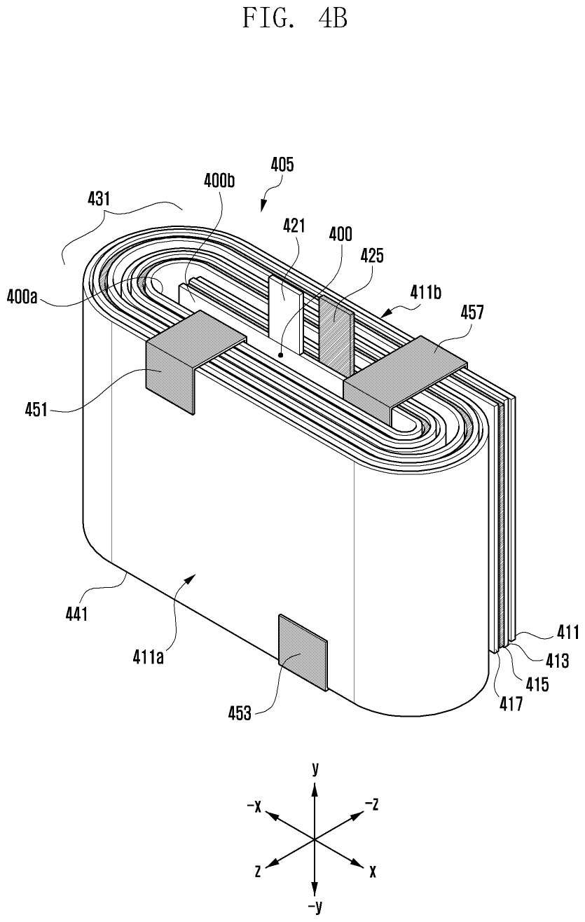

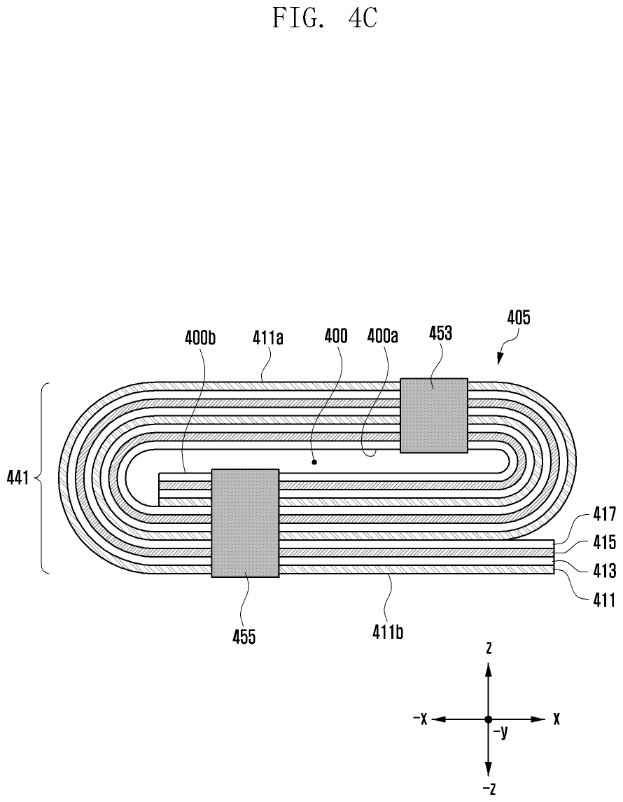

FIG. 4A is a view of a battery disposed inside an electronic device according to various embodiments when the battery is viewed in one direction (e.g., from the front side (in the z-axis direction). FIG. 4B is a perspective view of the electrode assembly according to various embodiments illustrated in FIG. 4A when the electrode assembly is rotated rightward (e.g., about 45°) and then viewed from the top side. FIG. 4C is a view of the electrode assembly illustrated in FIG. 4B when the electrode assembly is viewed in one direction (e.g., from the bottom side (in the −y-axis direction)) according to various embodiments.

The battery 350 illustrated in FIG. 4A may include the embodiments illustrated in the battery 189 illustrated in FIGS. 1A and 1B and/or the battery 350 illustrated in FIG. 3. In the description of the battery 350 illustrated in FIG. 4A, redundant descriptions of functions and configurations of the battery 189 illustrated in FIGS. 1A and 1B and/or the battery 350 illustrated in FIG. 3 may be omitted.

Referring to FIGS. 4A to 4C, the battery 350 according to various embodiments may include a pouch 401 and an electrode assembly 405.

According to an embodiment, the battery 350 may supply power to, for example, the processor 120 (including processing circuitry), the memory 130, the input module 150 (including circuitry), the sound output module 155, the audio module 170, the sensor module 176 (including at least one sensor), the haptic module 179, and/or the camera module 180 of the electronic device 101 illustrated in FIG. 1A, battery 350 may include, for example, a lithium ion battery. Each “module” herein may comprise circuitry.

According to an embodiment, the pouch 401 may include an electrode assembly 405. The pouch 401 may be, for example, a case (e.g., a can) having an internal space in which the electrode assembly 405 is included.

According to various embodiments, the pouch 401 may include a material capable of coping with a change in volume of the electrode assembly 405 (e.g., a secondary battery in the form of a jelly roll) corresponding to charging and discharging of the battery 350. The pouch 401 may include the electrode assembly 405 and may be sealed from the outside. In an embodiment, the pouch 401 may be formed of a metal such as aluminum or an aluminum alloy. In another embodiment, the pouch 401 may be manufactured by laminating nylon, aluminum, and polypropylene layers.

According to an embodiment, the electrode assembly 405 may include a positive electrode plate 411, a first separation membrane 413, a negative electrode plate 415, a second separation membrane 417, a positive electrode tab 421, a negative electrode tab 425, and/or at least one fixing member. The at least one fixing member may include a first fixing member 451, a second fixing member 453, a third fixing member 455, and/or a fourth fixing member 457. For example and without limitation, each fixing member may include, for example, a connector comprising an adhesive member (e.g., an adhesive tape) or any other type of connecting material and/or connector.

According to an embodiment, the electrode assembly 405 may be included in the pouch 401. The electrode assembly 405 may be disposed in the internal space of the pouch 401, and may be disposed together with an electrolyte through a sealing process after the electrolyte is introduced into the internal space.

According to an embodiment, the positive electrode plate 411, the first separation membrane 413, the negative electrode plate 415, and the second separation membrane 417 included in the electrode assembly 405 may be stacked and wound. The positive electrode plate 411, the first separation membrane 413, the negative electrode plate 415, and the second separation membrane 417 included in the electrode assembly 405 may overlap and be wound. For example, the positive electrode plate 411, the first separation membrane 413, the negative electrode plate 415, and the second separation membrane 417 may be wound to be provided in the form of a jelly roll. When the positive electrode plate 411 is formed in a jelly roll shape, it may be disposed on the outermost side of the electrode assembly 405. The first separation membrane 413 may be disposed on the inner side of the positive electrode plate 411 to be closer to the central portion 400 than the positive electrode plate 411. The negative electrode plate 415 may be disposed on the inner side of the first separation membrane 413 to be closer to the central portion 400 than the first separation membrane 413. The second separation membrane 417 may be disposed on the inner side of the negative electrode plate 415 to be closer to the central portion 400 than the negative electrode plate 415. The positive electrode plate 411 and the negative electrode plate 415 may be insulated by the first separation membrane 413.

According to various embodiments, the electrode assembly 405 of the battery 350 may convert chemical energy of the positive electrode plate 411 and the negative electrode plate 415 into electrical energy. In the electrode assembly 405, a positive electrode tab 421 and a negative electrode tab 425 may be disposed in the central portion 400 (e.g., the winding core in the form of a jelly roll) to be spaced apart from each other. The positive electrode tab 421 may be connected to a portion of the positive electrode plate 411. The negative electrode tab 425 may be connected to a portion of the negative electrode plate 415. Power may be supplied to, for example, the power management module 188 (including circuitry) illustrated in FIGS. 1A and 1B via the positive electrode tab 421 and the negative electrode tab 425.

According to various embodiments, the positive electrode plate 411 may be an electrode from which electrons flow out. Since a chemical reaction in which electrons are lost occurs in the positive electrode plate 411, the positive electrode plate 411 may be an electrode in which an oxidation reaction occurs. At least one surface of the positive electrode plate 411 may be coated with a positive active material for positive electrode activity.

According to various embodiments, the negative electrode plate 415 may be an electrode into which electrons flow. Since a chemical reaction to obtain electrons occurs in the negative electrode plate 415, the negative electrode plate 415 may be an electrode in which a reduction reaction occurs. At least one surface of the negative electrode plate 415 may be coated with a negative active material for negative electrode activity. The positive electrode plate 411 and the negative electrode plate 415 may have the first separation membrane 413 interposed therebetween, and may generate a current through an oxidation-reduction reaction.

According to various embodiments, the positive electrode plate 411 may include a plate or layer (e.g., an aluminum foil) including a metal such as aluminum. The negative electrode plate 415 may include a plate or layer (e.g., a copper foil) including a metal such as copper.

According to various embodiments, the first separation membrane 413 may be disposed between the positive electrode plate 411 and the negative electrode plate 415. The first separation membrane 413 may be a separation membrane that prevents the positive electrode plate 411 and the negative electrode plate 415 from being into contact with each other. The first separation membrane 413 may insulate the positive electrode plate 411 and the negative electrode plate 415 from each other. The first separation membrane 413 may prevent or reduce the likelihood of the positive electrode plate 411 and the negative electrode plate 415 from being shorted.

According to various embodiments, the first separation membrane 413 and the second separation membrane 417 may be formed of a porous polymer film such as polyethylene (PE) or polypropylene (PP).

According to various embodiments, a first outer surface 411a and a second outer surface 411b may be provided by the positive electrode plate 411 disposed on the outermost side of the electrode assembly 405. In the electrode assembly 405, a first inner surface 400a and a second inner surface 400b may be provided by the second separation membrane 417 disposed on the innermost side.

Referring to FIGS. 4A to 4C, in the electrode assembly 405, a portion of the positive electrode plate 411 viewed in one direction (e.g., the z-axis direction) may be understood as the first outer surface 411a. In the electrode assembly 405, a portion of the positive electrode plate 411 viewed in a direction (e.g., the −z-axis direction) opposite to the one direction (e.g., the z-axis direction) may be understood as the second outer surface 411b. The end of the electrode assembly 405 in the upward direction (e.g., the y-axis direction) may be understood as the upper end 431. The end of the electrode assembly 405 in a direction (e.g., the −y-axis direction) opposite to the upward direction (e.g., the y-axis direction) may be understood as the lower end 441. The portion of the electrode assembly 405 closer to the first outer surface 411a in the vicinity of the central portion 400 (e.g., the winding core in the form of a jelly roll) may be understood as the first inner surface 400a. The first inner surface 400a may be a portion of the second separation membrane 417. A portion of the electrode assembly 405 closer to the second outer surface 411b in the vicinity of the central portion 400 may be understood as the second inner surface 400b. The second inner surface 400b may be a portion of the second separation membrane 417.

According to an embodiment, the first fixing member 451 may couple (directly or indirectly) or fix (e.g., bond) a portion of the upper portion of the first inner surface 400a (e.g., a portion of the second separation membrane 417), a portion of the upper end 431, and a portion of the upper portion of the first outer surface 411a (e.g., a portion of the positive electrode plate 411) of the electrode assembly 405. The first fixing member 451 may be configured, for example, in a “∩” shape. When the first outer surface 411a is viewed from the front side (e.g., in the z-axis direction), the first fixing member 451 may be disposed on the upper portion of the first outer surface 411a in the first direction (e.g., the −x-axis direction). For example, the first fixing member 451 may prevent or reduce the likelihood of the portions of the positive electrode plate 411 and/or the negative electrode plate 415 disposed in the central portion 400 (e.g., the winding core) of the electrode assembly 405 from moving or breaking outward. For example and without limitation, a connector of each fixing member may be adhesive, or any other type of connector (e.g., adhesive material, bonding material, physical connecting element, etc.) as discussed above.

According to an embodiment, the second fixing member 453 may couple (directly or indirectly) or fix (e.g., bond) a portion of the lower portion of the first inner surface 400a (e.g., a portion of the second separation membrane 417), a portion of the lower end 441, and a portion of the lower portion of the first outer surface 411a (e.g., a portion of the positive electrode plate 411) of the electrode assembly 405. The second fixing member 453 may be configured, for example, in a “U” shape. When the first outer surface 411a is viewed from the front side (e.g., in the z-axis direction), the second fixing member 453 may be disposed on the lower portion of the first outer surface 411a in the second direction (e.g., the x-axis direction). The second fixing member 453 may prevent or reduce the likelihood of the portions of the positive electrode plate 411 and/or the negative electrode plate 415 disposed in the central portion 400 (e.g., the winding core) of the electrode assembly 405 from moving or breaking outward.

In an embodiment, the upper portion may be a portion in a direction in which the positive electrode tab 421 and the negative electrode tab 425 are located in the electrode assembly 405, and the lower portion may be understood as a portion opposite to the upper portion.

According to an embodiment, the third fixing member 455 may couple (directly or indirectly) or fix (e.g., bond) a portion of the lower portion of the second inner surface 400b (e.g., a portion of the second separation membrane 417), a portion of the lower end 441, and a portion of the lower portion of the second outer surface 411b (e.g., a portion of the positive electrode plate 411) of the electrode assembly 405. The third fixing member 455 may be configured, for example, in a “U” shape. When viewed from the front side of the second outer surface 411b (e.g., in the −z-axis direction), the third fixing member 455 may be disposed on the lower portion of the second outer surface 411b in the first direction (e.g., the −x-axis direction). The third fixing member 455 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to an embodiment, the fourth fixing member 457 may couple (directly or indirectly) or fix (e.g., bond) a portion of the upper portion of the second inner surface 400b (e.g., a portion of the second separation membrane 417), a portion of the upper end 431, and a portion of the upper portion of the second outer surface 411b (e.g., a portion of the positive electrode plate 411) of the electrode assembly 405. The fourth fixing member 457 may be configured, for example, in a “∩” shape. When viewed from the front side of the second outer surface 411b (e.g., in the −z-axis direction), the fourth fixing member 457 may be disposed on the lower portion of the second outer surface 411b in the second direction (e.g., the x-axis direction). The fourth fixing member 457 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to various embodiments, the first fixing member 451, the second fixing member 453, the third fixing member 455, or the fourth fixing member 457 may include an adhesive tape.

According to various embodiments, one or more of the first fixing member 451, the second fixing member 453, the third fixing member 455, or the fourth fixing member 457 may be disposed in order to prevent or reduce the likelihood of the portions of the positive electrode plate 411 and/or the negative electrode plate 415 disposed in the central portion 400 (e.g., the winding core) of the electrode assembly 405 from moving and/or breaking outward. Each embodiment herein may be used in combination with any other embodiment herein.

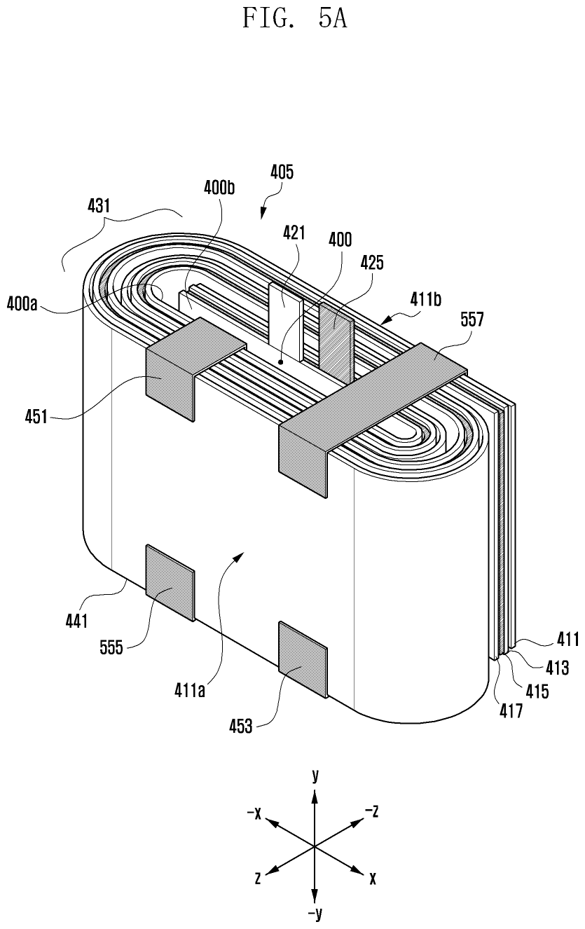

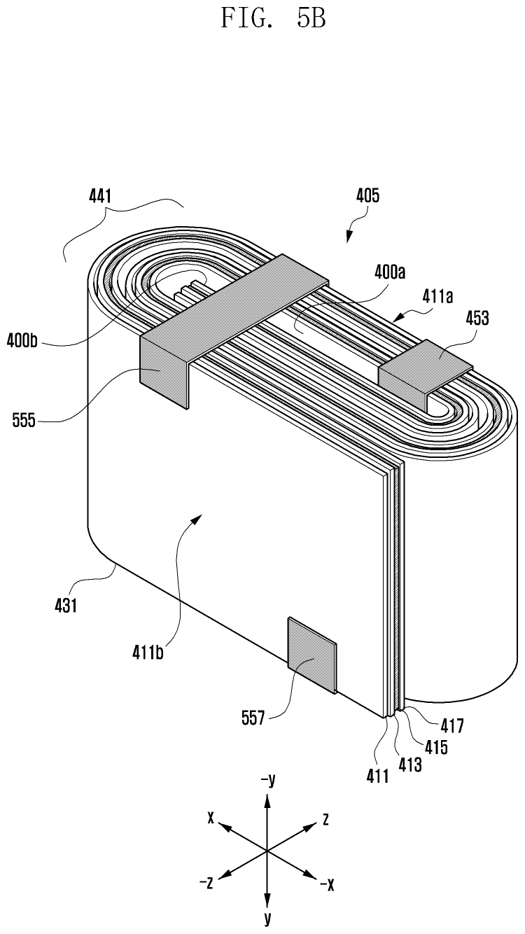

FIG. 5A is a perspective view of an electrode assembly of a battery according to various embodiments when the electrode assembly is viewed from top side (e.g., in the y-axis direction). FIG. 5B is a perspective view of the electrode assembly according to various embodiments illustrated in FIG. 5A when the electrode assembly is viewed from the bottom side (e.g., in the −y-axis side). For example, FIG. 5A may be a view of the electrode assembly according to various embodiments viewed from the top side, and FIG. 5B may be a view of the electrode assembly according to various embodiments viewed from the bottom side.

The electrode assembly 405 of FIGS. 5A and 5B may include the embodiments illustrated in the electrode assembly 405 illustrated in FIGS. 4A to 4C. The embodiments illustrated in the electrode assembly 405 of FIGS. 5A and 5B may be included in the electrode assembly 405 illustrated in FIGS. 4A to 4C. In the description of FIGS. 5A and 5B, the same reference numerals are assigned to the components which are substantially the same as those of the embodiment of the electrode assembly 405 described above with reference to FIGS. 4A to 4C, and overlapping descriptions thereof may be omitted.

Referring to FIGS. 5A and 5B, the electrode assembly 405 according to various embodiments may include a positive electrode plate 411, a first separation membrane 413, a negative electrode plate 415, a second separation membrane 417, a positive electrode tab 421, a negative electrode tab 425, and/or at least one fixing member. The at least one fixing member may include a first fixing member 451, a second fixing member 453, a third fixing member 555, and/or a fourth fixing member 557.

According to an embodiment, the positive electrode plate 411, the first separation membrane 413, the negative electrode plate 415, and the second separation membrane 417 included in the electrode assembly 405 may be stacked and wound. The positive electrode plate 411, the first separation membrane 413, the negative electrode plate 415, and the second separation membrane 417 may be wound to be provided in the form of a jelly roll. When the positive electrode plate 411 is formed in a jelly roll shape, it may be disposed on the outermost side of the electrode assembly 405. The first separation membrane 413 may be disposed on the inner side of the positive electrode plate 411 to be closer to the central portion 400 than the positive electrode plate 411. The negative electrode plate 415 may be disposed on the inner side of the first separation membrane 413 to be closer to the central portion 400 than the first separation membrane 413. The second separation membrane 417 may be disposed on the inner side of the negative electrode plate 415 to be closer to the central portion 400 than the negative electrode plate 415. The positive electrode plate 411 and the negative electrode plate 415 may be insulated by the first separation membrane 413.

According to various embodiments, a first outer surface 411a and a second outer surface 411b may be provided by the positive electrode plate 411 disposed on the outermost side of the electrode assembly 405. In the electrode assembly 405, a first inner surface 400a and a second inner surface 400b may be provided by the second separation membrane 417 disposed on the innermost side.

Referring to FIGS. 5A and 5B, in the electrode assembly 405, a portion of the positive electrode plate 411 viewed in one direction (e.g., the z-axis direction) may be understood as the first outer surface 411a. In the electrode assembly 405, a portion of the positive electrode plate 411 viewed in the direction (e.g., the −z-axis direction) opposite to the one direction (e.g., the z-axis direction) may be understood as the second outer surface 411b. The end of the electrode assembly 405 in the upward direction (e.g., the y-axis direction) may be understood as the upper end 431. The end of the electrode assembly 405 in a direction (e.g., the −y-axis direction) opposite to the upward direction (e.g., the y-axis direction) may be understood as the lower end 441. The portion of the electrode assembly 405 closer to the first outer surface 411a in the vicinity of the central portion 400 (e.g., the winding core in the form of a jelly roll) may be understood as the first inner surface 400a. The first inner surface 400a may be a portion of the second separation membrane 417. A portion of the electrode assembly 405 closer to the second outer surface 411b in the vicinity of the central portion 400 may be understood as the second inner surface 400b. The second inner surface 400b may be a portion of the second separation membrane 417.

According to an embodiment, the first fixing member 451 may couple or fix (e.g., bond) a portion of the upper portion of the first inner surface 400a (e.g., a portion of the second separation membrane 417), a portion of the upper end 431, and a portion of the upper portion of the first outer surface 411a (e.g., a portion of the positive electrode plate 411) of the electrode assembly 405. The first fixing member 451 may be configured, for example, in a “∩” shape. When the first outer surface 411a is viewed from the front side (e.g., in the z-axis direction), the first fixing member 451 may be disposed on the upper portion of the first outer surface 411a in the first direction (e.g., the −x-axis direction). For example, the first fixing member 451 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to an embodiment, the second fixing member 453 may couple or fix (e.g., bond) a portion of the lower portion of the first inner surface 400a (e.g., a portion of the second separation membrane 417), a portion of the lower end 441, and a portion of the lower portion of the first outer surface 411a (e.g., a portion of the positive electrode plate 411) of the electrode assembly 405. The second fixing member 453 may be configured, for example, in a “U” shape. When the first outer surface 411a is viewed from the front side (e.g., in the z-axis direction), the second fixing member 453 may be disposed on the lower portion of the first outer surface 411a in the second direction (e.g., the x-axis direction). For example, the second fixing member 453 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to an embodiment, the third fixing member 555 may couple or fix (e.g., bond) a portion of the lower portion of the first outer surface 411a (e.g., a portion of the positive electrode plate 411), a portion of the lower end 441, and a portion of the lower portion of the second outer surface 411b (e.g., a portion of the positive electrode plate 411) of the electrode assembly 405. The third fixing member 555 may be configured, for example, in a “U” shape. When viewed from the front side of the first outer surface 411a (e.g., in the z-axis direction), the third fixing member 555 may be disposed on the lower portion of the first outer surface 411a in the first direction (e.g., the −x-axis direction). For example, the third fixing member 555 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to an embodiment, the fourth fixing member 557 may couple or fix (e.g., bond) a portion of the upper portion of the first outer surface 411a (e.g., a portion of the positive electrode plate 411), a portion of the upper end 431, and a portion of the upper portion of the second outer surface 411b (e.g., a portion of the positive electrode plate 411) of the electrode assembly 405. The fourth fixing member 557 may be configured, for example, in a “∩” shape. When viewed from the front side of the first outer surface 411a (e.g., in the z-axis direction), the fourth fixing member 557 may be disposed on the upper portion of the first outer surface 411a in the second direction (e.g., the x-axis direction). For example, the fourth fixing member 557 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to various embodiments, the first fixing member 451 and the second fixing member 453 illustrated in FIGS. 5A and 5B may be configured to be substantially the same as the first fixing member and the second fixing member illustrated in FIGS. 4A to 4C described above.

According to various embodiments, the third fixing member 555 illustrated in FIGS. 5A and 5B may be different from the third fixing member 455 illustrated in FIGS. 4A to 4C described above in that the former is able to couple or fix (e.g., bond) a portion of the lower portion of the first outer surface 411a (e.g., a portion of the positive electrode plate 411), a portion of the lower end 441, and a portion of the lower portion of the second outer surface 411b (e.g., a portion of the positive electrode plate 411) of the electrode assembly 405, but the latter couples (e.g., bonds) a portion of the lower portion of the second inner surface 400b (e.g., a portion of the second separation membrane 417), a portion of the lower end 441, and a portion of the lower portion of the second outer surface 411b (e.g., a portion of the positive electrode plate 411) of the electrode assembly 405.

According to various embodiments, the fourth fixing member 557 illustrated in FIGS. 5A and 5B may be different from the third fixing member 457 illustrated in FIGS. 4A to 4C described above in that the former is able to couple or fix (e.g., bond) a portion of the upper portion of the first outer surface 411a (e.g., a portion of the positive electrode plate 411), a portion of the upper end 431, and a portion of the upper portion of the second outer surface 411b (e.g., a portion of the positive electrode plate 411) of the electrode assembly 405, but the latter couples (e.g., bonds) a portion of the upper portion of the second inner surface 400b (e.g., a portion of the second separation membrane 417), a portion of the upper end 431, and a portion of the upper portion of the second outer surface 411b (e.g., a portion of the positive electrode plate 411) of the electrode assembly 405.

According to various embodiments, the length of the third fixing member 555 or the fourth fixing member 557 may be longer than the length of the first fixing member 451 or the second fixing member 453.

According to various embodiments, one or more of the first fixing member 451, the second fixing member 453, the third fixing member 555, or the fourth fixing member 557 illustrated in FIGS. 5A and 5B may be disposed in order to prevent or reduce the likelihood of the portions of the positive electrode plate 411 and/or the negative electrode plate 415 disposed in the central portion 400 (e.g., the winding core) of the electrode assembly 405 from moving and/or breaking outward.

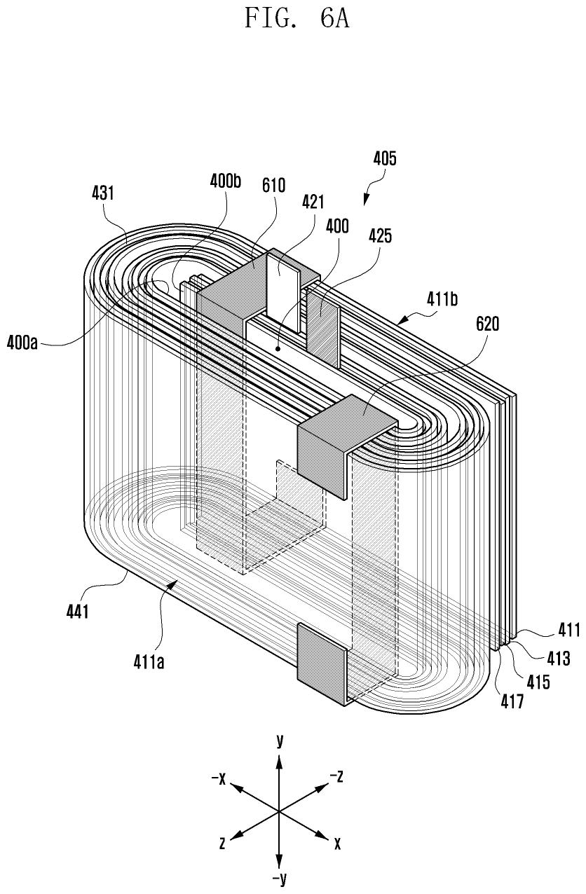

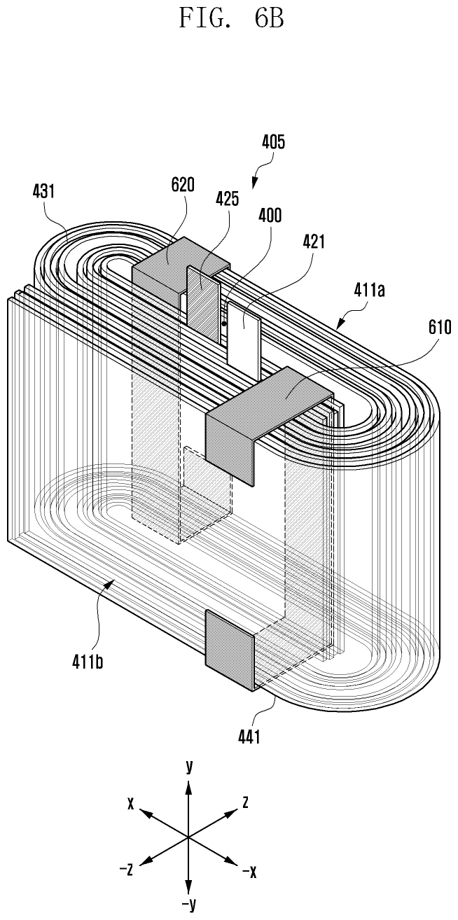

FIG. 6A is a perspective view of an electrode assembly of a battery according to various embodiments when the electrode assembly is viewed from top side (e.g., in the y-axis direction). FIG. 6B is a perspective view of the electrode assembly according to various embodiments illustrated in FIG. 6A when the electrode assembly is rotated (e.g., about 180°) and viewed from the top side (e.g., in the y-axis direction).

The electrode assembly 405 of FIGS. 6A and 6B may include the embodiments illustrated in the electrode assembly 405 illustrated in FIGS. 4A to 4C and/or FIGS. 5A and 5B above. The embodiments illustrated in the electrode assembly 405 of FIGS. 6A and 6B may be included in the embodiments of the electrode assembly 405 illustrated in FIGS. 4A to 4C and/or FIGS. 5A and 5B above. In the description of FIGS. 6A and 6B, the same reference numerals are assigned to the components which are substantially the same as those of the embodiment of the electrode assembly 405 described above with reference to FIGS. 4A to 4C and/or FIGS. 5A and 5B, and overlapping descriptions thereof may be omitted.

Referring to FIGS. 6A and 6B, the electrode assembly 405 according to various embodiments may include a positive electrode plate 411, a first separation membrane 413, a negative electrode plate 415, a second separation membrane 417, a positive electrode tab 421, a negative electrode tab 425, and/or at least one fixing member. The at least one fixing member may include a fifth fixing member 610 and/or a sixth fixing member 620.

According to an embodiment, the positive electrode plate 411, the first separation membrane 413, the negative electrode plate 415, and the second separation membrane 417 included in the electrode assembly 405 may be stacked and wound. For example, the positive electrode plate 411, the first separation membrane 413, the negative electrode plate 415, and the second separation membrane 417 may be wound to be provided in the form of a jelly roll. When the positive electrode plate 411 is formed in a jelly roll shape, it may be disposed on the outermost side of the electrode assembly 405. The first separation membrane 413 may be disposed on the inner side of the positive electrode plate 411 to be closer to the central portion 400 than the positive electrode plate 411. The negative electrode plate 415 may be disposed on the inner side of the first separation membrane 413 to be closer to the central portion 400 than the first separation membrane 413. The second separation membrane 417 may be disposed on the inner side of the negative electrode plate 415 to be closer to the central portion 400 than the negative electrode plate 415. The positive electrode plate 411 and the negative electrode plate 415 may be insulated by the first separation membrane 413.

According to various embodiments, a first outer surface 411a and a second outer surface 411b may be provided by the positive electrode plate 411 disposed on the outermost side of the electrode assembly 405. In the electrode assembly 405, a first inner surface 400a and a second inner surface 400b may be provided by the second separation membrane 417 disposed on the innermost side.

Referring to FIGS. 6A and 6B, in the electrode assembly 405, a portion of the positive electrode plate 411 viewed in one direction (e.g., the z-axis direction) may be understood as the first outer surface 411a. In the electrode assembly 405, a portion of the positive electrode plate 411 viewed in the direction (e.g., the −z-axis direction) opposite to the one direction (e.g., the z-axis direction) may be understood as the second outer surface 411b. The end of the electrode assembly 405 in the upward direction (e.g., the y-axis direction) may be understood as an upper end 431. The end of the electrode assembly 405 in a direction opposite to the upward direction (e.g., the −y-axis direction) may be understood as a lower end 441. The portion of the electrode assembly 405 closer to the first outer surface 411a in the vicinity of the central portion 400 (e.g., the winding core in the form of a jelly roll) may be understood as the first inner surface 400a. The first inner surface 400a may be a portion of the second separation membrane 417. A portion of the electrode assembly 405 closer to the second outer surface 411b in the vicinity of the central portion 400 may be understood as the second inner surface 400b. The second inner surface 400b may be a portion of the second separation membrane 417.

According to an embodiment, the fifth fixing member 610 may couple or fix (e.g., bond) a portion of the upper portion of the second outer surface 411b (e.g., a portion of the upper portion of the positive electrode plate 411), a portion of the upper end 431, a portion of the second inner surface 400b (e.g., a portion of the second separation membrane 417), a portion of the lower end 441, and a portion of the lower portion of the second outer surface 411b (e.g., a portion of the lower portion of the positive electrode plate 411) of the electrode assembly 405. For example, a portion of the fifth fixing member 610 may be configured to extend from the upper end 431 to the lower end 441. When the second outer surface 411b is viewed from the front side (e.g., in the −z-axis direction), the fifth fixing member 610 may be disposed in the first direction (e.g., the −x-axis direction). The fifth fixing member 610 may prevent or reduce the likelihood of the portions of the positive electrode plate 411 and the negative electrode plate 415 disposed in the central portion 400 (e.g., the winding core) of the electrode assembly 405 from moving or breaking outward.

According to an embodiment, the sixth fixing member 620 may couple or fix (e.g., bond) a portion of the upper portion of the first outer surface 411a (e.g., a portion of the upper portion of the positive electrode plate 411), a portion of the upper end 431, a portion of the first inner surface 400a (e.g., a portion of the second separation membrane 417), a portion of the lower end 441, and a portion of the lower portion of the first outer surface 411a (e.g., a portion of the lower portion of the positive electrode plate 411) of the electrode assembly 405. For example, a portion of the sixth fixing member 620 may be configured to extend from the upper end 431 to the lower end 441. When the first outer surface 411a is viewed from the front side (e.g., in the z-axis direction), the sixth fixing member 620 may be disposed in the second direction (e.g., the x-axis direction). The sixth fixing member 620 may prevent or reduce the likelihood of the portions of the positive electrode plate 411 and the negative electrode plate 415 disposed in the central portion 400 (e.g., the winding core) of the electrode assembly 405 from moving or breaking outward.

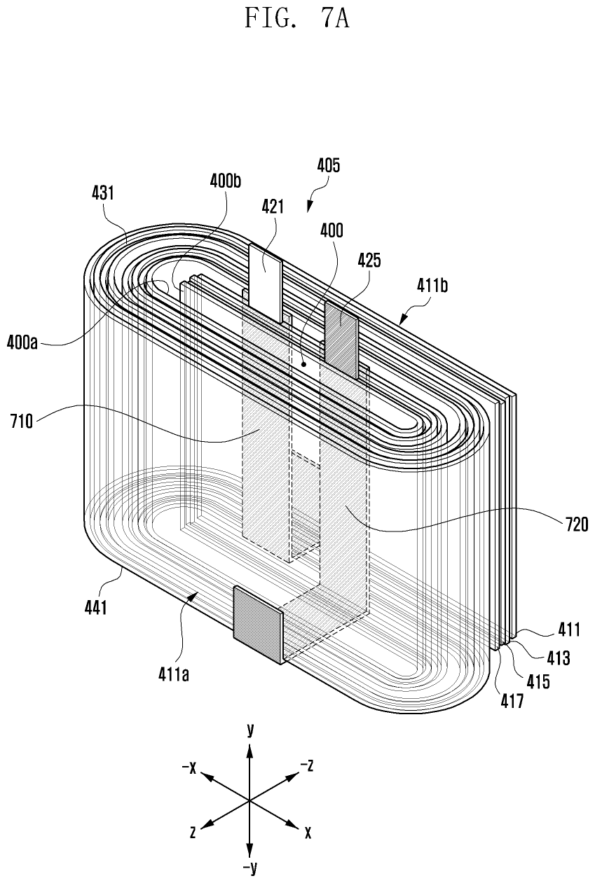

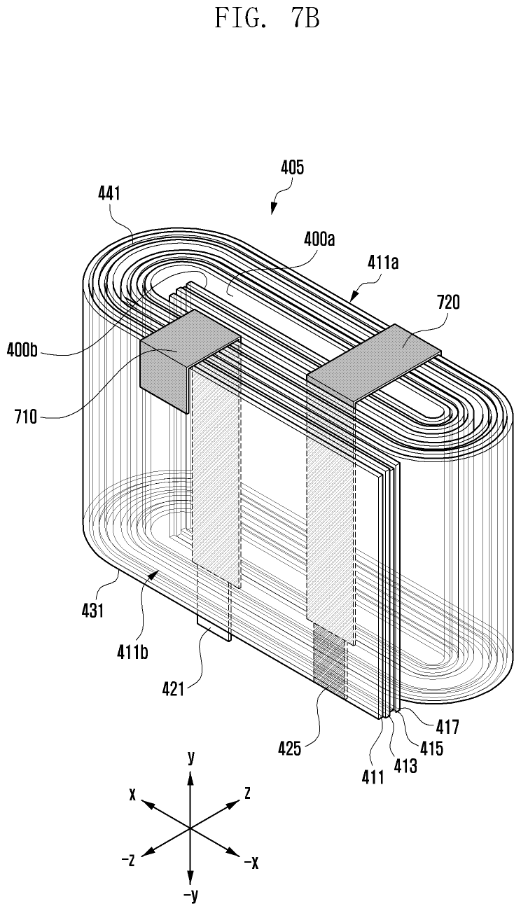

FIG. 7A is a perspective view of an electrode assembly of a battery according to various embodiments when viewed from top side (e.g., in the y-axis direction). FIG. 7B is a perspective view of the electrode assembly according to various embodiments illustrated in FIG. 7A when viewed from the bottom side (e.g., in the −y-axis side).

The electrode assembly 405 of FIGS. 7A and 7B may include the embodiments illustrated in the electrode assembly 405 illustrated in FIGS. 4A to 4C, FIGS. 5A and 5B, and/or FIGS. 6A and 6B above. The embodiments illustrated in the electrode assembly 405 of FIGS. 7A and 7B may be included in the electrode assembly 405 illustrated in FIGS. 4A to 4C, FIGS. 5A and 5B, and/or FIGS. 6A and 6B. In the description of FIGS. 7A and 7B, the same reference numerals are assigned to the components which are substantially the same as those of the embodiment of the electrode assembly 405 described above with reference to FIGS. 4A to 4C, FIGS. 5A and 5B, and/or FIGS. 6A and 6B and overlapping descriptions thereof may be omitted.

Referring to FIGS. 7A and 7B, the electrode assembly 405 according to various embodiments may include a positive electrode plate 411, a first separation membrane 413, a negative electrode plate 415, a second separation membrane 417, a positive electrode tab 421, a negative electrode tab 425, and/or at least one tape. According to an embodiment, the at least one tape may include a first tape 710 or a second tape 720.

According to an embodiment, in the electrode assembly 405, a positive electrode tab 421 and a negative electrode tab 425 may be disposed in the central portion 400 (e.g., the winding core in the form of a jelly roll). The positive electrode tab 421 and the negative electrode tab 425 may be spaced apart from each other. The positive electrode tab 421 may be connected to a portion of the positive electrode plate 411. The negative electrode tab 425 may be connected to a portion of the negative electrode plate 415. Power may be supplied to, for example, the power management module 188 illustrated in FIGS. 1A and 1B via the positive electrode tab 421 and the negative electrode tab 425.

According to an embodiment, the positive electrode plate 411, the first separation membrane 413, the negative electrode plate 415, and the second separation membrane 417 included in the electrode assembly 405 may be stacked and wound. For example, the positive electrode plate 411, the first separation membrane 413, the negative electrode plate 415, and the second separation membrane 417 may be wound to be provided in the form of a jelly roll. When the positive electrode plate 411 is formed in a jelly roll shape, it may be disposed on the outermost side of the electrode assembly 405. The first separation membrane 413 may be disposed on the inner side of the positive electrode plate 411 to be closer to the central portion 400 than the positive electrode plate 411. The negative electrode plate 415 may be disposed on the inner side of the first separation membrane 413 to be closer to the central portion 400 than the first separation membrane 413. The second separation membrane 417 may be disposed on the inner side of the negative electrode plate 415 to be closer to the central portion 400 than the negative electrode plate 415. The positive electrode plate 411 and the negative electrode plate 415 may be insulated by the first separation membrane 413.

According to various embodiments, a first outer surface 411a and a second outer surface 411b may be provided by the positive electrode plate 411 disposed on the outermost side of the electrode assembly 405. In the electrode assembly 405, a first inner surface 400a and a second inner surface 400b may be provided by the second separation membrane 417 disposed on the innermost side.

Referring to FIGS. 7A and 7B, in the electrode assembly 405, a portion of the positive electrode plate 411 viewed in one direction (e.g., the z-axis direction) may be understood as the first outer surface 411a. In the electrode assembly 405, a portion of the positive electrode plate 411 viewed in the direction (e.g., the −z-axis direction) opposite to the one direction (e.g., the z-axis direction) may be understood as the second outer surface 411b. The end of the electrode assembly 405 in the upward direction (e.g., the y-axis direction) may be understood as an upper end 431. The end of the electrode assembly 405 in a direction (e.g., the −y-axis direction) opposite to the upward direction (e.g., the y-axis direction) may be understood as the lower end 441. A portion of the electrode assembly 405 closer to the first outer surface 411a in the vicinity of the central portion 400 (e.g., the winding core in the form of a jelly roll) may be understood as the first inner surface 400a. The first inner surface 400a may be a portion of the second separation membrane 417. A portion of the electrode assembly 405 closer to the second outer surface 411b in the vicinity of the central portion 400 may be understood as the second inner surface 400b. The second inner surface 400b may be a portion of the second separation membrane 417.

According to an embodiment, the first tape 710 may be bonded to at least a portion of the positive electrode tab 421. The first tape 710 may cover at least a portion of the positive electrode tab 421.

According to an embodiment, one end of the first tape 710 may be bonded to at least a portion of the positive electrode tab 421, and may couple or fix (e.g., bond) a portion of the positive electrode plate 411 adjacent and/or proximate to the central portion 400 (e.g., the winding core), a portion of the lower end 441, and a portion of the lower portion of the second outer surface 411b (e.g., a portion of the positive electrode plate 411). According to various embodiments, one end of the first tape 710 may be bonded to at least a portion of the positive electrode tab 421, and may couple or fix (e.g., bond) a space between the positive electrode plate 411 and the first separation membrane 413 adjacent and/or proximate to the central portion 400 (e.g., the winding core), a portion of the lower end 441, and a portion of the lower portion of the second outer surface 411b (e.g., a portion of the positive electrode plate 411). When the second outer surface 411b is viewed from the front side (e.g., in the −z-axis direction), the first tape 710 may be disposed in the first direction (e.g., the −x-axis direction). The first tape 710 may prevent or reduce the likelihood of the portions of the positive electrode plate 411 and/or the negative electrode plate 415 disposed in the central portion 400 (e.g., the winding core) of the electrode assembly 405 from moving and/or breaking outward.

According to various embodiments, one end of the second tape 720 may be bonded to at least a portion of the negative electrode tab 425, and may couple (e.g., bond) a space between the negative electrode plate 415 and the second separation membrane 417 adjacent and/or proximate to the central portion 400 (e.g., the winding core), a portion of the lower end 441, and a portion of the lower portion of the first outer surface 411a (e.g., a portion of the positive electrode plate 411). When the first outer surface 411a is viewed from the front side (e.g., in the z-axis direction), the second tape 720 may be disposed in the second direction (e.g., the x-axis direction). The second tape 720 may prevent or reduce the likelihood of the portions of the positive electrode plate 411 and the negative electrode plate 415 disposed in the central portion 400 (e.g., the winding core) of the electrode assembly 405 from moving or breaking outward.

Various embodiments provide an electronic device 101, 200, or 300 including a battery 189 or 350, wherein the battery 189 or 350 may include: a pouch 401; a first fixing member 451; a second fixing member 453; and an electrode assembly 405 which is included in the pouch 401 and in which a positive electrode plate 411 disposed on the outermost side, a first separation membrane 413 disposed on an inner side of the positive electrode plate, a negative electrode plate 415 disposed on the inner side of the first separation membrane, and a second separation membrane 417 disposed on the inner side of the negative electrode plate are stacked and wound, wherein the positive electrode plate 411 may include a first outer surface 411aoriented in one direction, and a second outer surface 411b oriented in a direction opposite to the one direction, wherein the electrode assembly 405 may include an upper end 431 oriented in an upward direction and a lower end 441 oriented in a direction opposite to the upward direction, wherein the second separation membrane 417 may include a first inner surface 400a adjacent and/or proximate to the first outer surface 411a in the vicinity of a central portion 400 thereof and a second inner surface 400b adjacent and/or proximate to the second outer surface 411b in the vicinity of the central portion 400, wherein the first fixing member 451 may be configured to couple a portion of an upper portion of the first inner surface 400a, a portion of the upper end 431, and a portion of an upper portion of the first outer surface 411a, and wherein the second fixing member 453 may be configured to couple a portion of the lower portion of the first inner surface 400a, a portion of the lower end 441, and a portion of the lower portion of the first outer surface 411a.

According to various embodiments, in the electrode assembly 405, a positive electrode tab 421 may be connected to the positive electrode plate 411 disposed in the central portion 400, a negative electrode tab 425 may be connected to the negative electrode plate 415 disposed in the central portion 400, and the positive electrode tab 421 and the negative electrode tab 425 may be spaced apart from each other.

According to various embodiments, the first inner surface 400a and the second inner surface 400b may be a portion of the second separation membrane 417.

According to various embodiments, a portion of a lower portion of the second inner surface 400b, a portion of the lower end 441, and a portion of a lower portion of the second outer surface 411b may be coupled by using a third fixing member 455.

According to various embodiments, a portion of an upper portion of the second inner surface 400b, a portion of the upper end 431, and a portion of an upper portion of the second outer surface 411b may be coupled by using a fourth fixing member 457.

According to various embodiments, the electrode assembly 405 may include a third fixing member 555 configured to couple a portion of a lower portion of the first outer surface 411a, a portion of the lower end 441, and a portion of a lower portion of the second outer surface 411b.

According to various embodiments, the electrode assembly 405 may include a fourth fixing member 557 configured to couple a portion of an upper portion of the first outer surface 411a, a portion of the upper end 431, and a portion of an upper portion of the second outer surface 411b.

According to various embodiments, the electrode assembly 405 may include a fifth fixing member 610 configured to couple a portion of an upper portion of the second outer surface 411b, a portion of the upper end 431, the second inner surface 400b, a portion of the lower end 441, and a portion of a lower portion of the second outer surface 411b.

According to various embodiments, the electrode assembly 405 may include a sixth fixing member 620 configured to couple a portion of an upper portion of the first outer surface 411a, a portion of the upper end 431, the first inner surface 400a, a portion of the lower end 441, and a portion of a lower portion of the first outer surface 411a.

Various embodiments provide an electronic device 101, 200, or 300 including a battery 189 or 350, wherein the battery 189 or 350 may include: a pouch 401; and an electrode assembly 405 which is included in the pouch 401 and in which a positive electrode plate 411 disposed on the outermost side, a first separation membrane 413 disposed on an inner side of the positive electrode plate, a negative electrode plate 415 disposed on the inner side of the first separation membrane, and a second separation membrane 417 disposed on the inner side of the negative electrode plate are stacked and wound, wherein the positive electrode plate 411 may include a first outer surface 411a oriented in one direction, and a second outer surface 411b oriented in a direction opposite to the one direction, wherein the electrode assembly 405 may include an upper end 431 oriented in an upward direction and a lower end 441 oriented in a direction opposite to the upward direction, wherein the second separation membrane 417 may include a first inner surface 400a adjacent and/or proximate to the first outer surface 411a in the vicinity of a central portion 400 thereof and a second inner surface 400b adjacent and/or proximate to the second outer surface 411b in the vicinity of the central portion 400, wherein a positive electrode tab 421 may be connected to the positive electrode plate 411 disposed in the central portion 400, a negative electrode tab 425 may be connected to the negative electrode plate 415 disposed in the central portion 400, and at least a portion of the positive electrode tab 421, a portion of the positive electrode plate 411 adjacent and/or proximate to the central portion 400, a portion of the lower end 441, and a portion of a lower portion of the second outer surface 411b may be coupled by using a first tape 710.

According to various embodiments, at least a portion of the negative electrode tab 425, a space between the negative electrode plate 415 and the second separation membrane 417 adjacent to the central portion 400, a portion of the lower end 441, and a portion of the lower portion of the first outer surface 411a may be coupled by using the second tape 720. Any fixing member herein may be, for example and without limitation, a connector such as adhesive and/or tape.

In the foregoing, the disclosure has been described with reference to various embodiments of the disclosure, but it is evident that changes and modifications made by a person ordinarily skilled in the art to which the disclosure belongs without departing from the technical spirit of the disclosure fall within the scope of the disclosure.

1. An electronic device comprising:
a battery,
wherein the battery includes:
a pouch;
a first fixing member comprising a connector;
a second fixing member comprising a connector; and
an electrode assembly which is included in the pouch and which comprises a positive electrode plate disposed on an outermost side, a first separation membrane disposed on an inner side of the positive electrode plate, a negative electrode plate disposed on an inner side of the first separation membrane, and a second separation membrane disposed on an inner side of the negative electrode plate, stacked and wound,
wherein the positive electrode plate includes a first outer surface oriented in a first direction, and a second outer surface oriented in a second direction opposite to the first direction,
wherein the electrode assembly includes an upper end oriented in an upward direction and a lower end oriented in a direction opposite to the upward direction,
wherein the second separation membrane includes a first inner surface adjacent and/or proximate to the first outer surface in a vicinity of a central portion thereof and a second inner surface adjacent and/or proximate to the second outer surface in the vicinity of the central portion,
wherein the first fixing member is configured to couple a portion of an upper portion of the first inner surface, a portion of the upper end, and a portion of an upper portion of the first outer surface, and
wherein the second fixing member is configured to couple a portion of the lower portion of the first inner surface, a portion of the lower end, and a portion of the lower portion of the first outer surface.

2. The electronic device of claim 1, wherein a positive electrode tab is connected to the positive electrode plate disposed in the central portion,
a negative electrode tab is connected to the negative electrode plate disposed in the central portion, and
the positive electrode tab and the negative electrode tab are spaced apart from each other.

3. The electronic device of claim 1, wherein the first inner surface and the second inner surface are a portion of the second separation membrane.

4. The electronic device of claim 1, wherein a portion of a lower portion of the second inner surface, a portion of the lower end, and a portion of a lower portion of the second outer surface are configured to be coupled via at least a third fixing member comprising a connector.

5. The electronic device of claim 1, wherein a portion of an upper portion of the second inner surface, a portion of the upper end, and a portion of an upper portion of the second outer surface are configured to be coupled via at least a fourth fixing member comprising a connector.

6. The electronic device of claim 1, further comprising:
a third fixing member comprising a connector configured to couple a portion of a lower portion of the first outer surface, a portion of the lower end, and a portion of a lower portion of the second outer surface.

7. The apparatus of claim 1, further comprising:
a fourth fixing member comprising a connector configured to couple a portion of an upper portion of the first outer surface, a portion of the upper end, and a portion of an upper portion of the second outer surface, wherein the connector comprises adhesive.

8. The electronic device of claim 1, further comprising:
a fifth fixing member comprising a connector configured to couple a portion of an upper portion of the second outer surface, a portion of the upper end, the second inner surface, a portion of the lower end, and a portion of a lower portion of the second outer surface.

9. The electronic device of claim 1, further comprising:
a sixth fixing member comprising a connector configured to couple a portion of an upper portion of the first outer surface, a portion of the upper end, the first inner surface, a portion of the lower end, and a portion of a lower portion of the first outer surface.

10. A battery comprising:
a pouch;
a first fixing member comprising a connector;
a second fixing member comprising a connector; and
an electrode assembly included in the pouch and comprising a positive electrode disposed on an outermost side, a first separation membrane disposed on an inner side of the positive electrode, a negative electrode disposed on an inner side of the first separation membrane, and a second separation membrane disposed on an inner side of the negative electrode,
wherein the positive electrode includes a first outer surface oriented in first direction, and a second outer surface oriented in a second direction opposite to the first direction,
wherein the electrode assembly includes an upper end oriented in an upward direction and a lower end oriented in a direction opposite to the upward direction,
wherein the second separation membrane includes a first inner surface adjacent and/or proximate to the first outer surface in a vicinity of a central portion thereof and a second inner surface adjacent and/or proximate to the second outer surface in the vicinity of the central portion,
wherein the first fixing member is configured to couple a portion of an upper portion of the first inner surface, a portion of the upper end, and a portion of an upper portion of the first outer surface, and
wherein the second fixing member is configured to couple a portion of the lower portion of the first inner surface, a portion of the lower end, and a portion of the lower portion of the first outer surface.

11. The battery of claim 10, wherein a positive electrode tab is connected to the positive electrode disposed in the central portion,
a negative electrode tab is connected to the negative electrode disposed in the central portion, and
the positive electrode tab and the negative electrode tab are spaced apart from each other.

12. The battery of claim 10, wherein the first inner surface and the second inner surface are a portion of the second separation membrane.

13. The battery of claim 10, wherein a portion of a lower portion of the second inner surface, a portion of the lower end, and a portion of a lower portion of the second outer surface are configured to be coupled via at least a third fixing member comprising a connector.

14. The battery of claim 10, wherein a portion of an upper portion of the second inner surface, a portion of the upper end, and a portion of an upper portion of the second outer surface are configured to be coupled via at least a fourth fixing member comprising a connector.

15. The battery of claim 10, further comprising:
a third fixing member, comprising a connector, configured to couple a portion of a lower portion of the first outer surface, a portion of the lower end, and a portion of a lower portion of the second outer surface, wherein the connector comprises adhesive.

16. The battery of claim 10, further comprising:
a fourth fixing member, comprising a connector, configured to couple a portion of an upper portion of the first outer surface, a portion of the upper end, and a portion of an upper portion of the second outer surface.

17. The battery of claim 10, further comprising:
a fifth fixing member, comprising a connector, configured to couple a portion of an upper portion of the second outer surface, a portion of the upper end, the second inner surface, a portion of the lower end, and a portion of a lower portion of the second outer surface.

18. The battery of claim 10, further comprising:
a sixth fixing member, comprising a connector, configured to couple a portion of an upper portion of the first outer surface, a portion of the upper end, the first inner surface, a portion of the lower end, and a portion of a lower portion of the first outer surface.

19. An electronic device comprising:
a battery,
wherein the battery includes:
a pouch; and
an electrode assembly included in the pouch and comprising a positive electrode disposed on an outermost side, a first separation membrane disposed on an inner side of the positive electrode, a negative electrode disposed on an inner side of the first separation membrane, and a second separation membrane disposed on an inner side of the negative electrode,
wherein the positive electrode includes a first outer surface oriented in a first direction, and a second outer surface oriented in a direction opposite to the first direction,
wherein the electrode assembly includes an upper end oriented in an upward direction and a lower end oriented in a direction generally opposite to the upward direction, wherein the second separation membrane includes a first inner surface adjacent and/or proximate to the first outer surface in a vicinity of a central portion thereof and a second inner surface adjacent and/or proximate to the second outer surface in the vicinity of the central portion,
wherein a positive electrode tab is connected to the positive electrode disposed in the central portion, and a negative electrode tab is connected to the negative electrode disposed in the central portion, and
wherein at least a portion of the positive electrode tab, a portion of the positive electrode plate adjacent and/or proximate to the central portion, a portion of the lower end, and a portion of a lower portion of the second outer surface are configured to be coupled via at least a first tape.

20. The electronic device of claim 19, wherein at least a portion of the negative electrode tab, a space between the negative electrode and the second separation membrane adjacent and/or proximate to the central portion, a portion of the lower end, and a portion of a lower portion of the first outer surface are configured to be coupled via at least a second tape.
